(19) United States
(12) Patent Application Publication
(10) Pub. No.: US 2016/0111762 A1
(43) Pub. Date: Apr. 21, 2016

(54) ELECTRICAL STORAGE APPARATUS

(71) Applicant: Toyota Jidosha Kabushiki Kaisha, Toyota-shi (JP)

(72) Inventors: Yoshiaki Kawakami, Nagoya-shi Aichi-ken (JP); Masatoshi Kouno, Toyota-shi Aichi-ken (JP)

(21) Appl. No.: 14/884,214

(22) Filed: Oct. 15, 2015

(30) Foreign Application Priority Data
Oct. 17, 2014 (JP) 2014-213126

(51) Int. Cl. H01M 10/6557; H01M 10/625

(52) U.S. Cl. CPC H01M 10/6557; H01M 10/625; H01M 2220/20

(57) ABSTRACT

An electrical storage apparatus of the invention has a first and a second electrical storage module arranged in a first direction. Each of the electrical storage modules has a plurality of cylindrical electrical storage elements, a support plate and a casing. The support plate supports a portion of each of the electrical storage elements. The casing surrounds the plurality of electrical storage elements and the support plate to form a space in which air moves. The casing has an air intake opening for moving air from a passage into the space and an air discharge opening for moving the air in the space out of the casing. The passage for moving the air in a second direction orthogonal to the first direction is formed between the first and second storage modules, and the air is used for regulating temperature of each of the electrical storage modules.

### INCORPORATION BY REFERENCE

The disclosure of Japanese Patent Application No. 2014-213126 filed on Oct. 17, 2014 including the specification, drawings and abstract is incorporated herein by reference in its entirety.

### BACKGROUND OF THE INVENTION

1. Field of the Invention

The invention relates to an electrical storage apparatus in which air for regulating temperature is supplied to two electrical storage modules.

2. Description of Related Art

In International Patent Application Publication No. 2014/083600 (WO 2014/083600 A1), by forming a battery module using a plurality of cylindrical single cells and supplying a heat exchange medium to the battery module, temperature of the single cells are regulated. Herein, the heat exchange medium is supplied to the battery module from a chamber by connecting the chamber with the battery module.

In WO 2014/083600 A1, when a plurality of battery modules are arranged, each of the battery modules will be connected to a chamber. Thus, the number of chambers will increase as the number of battery modules increases.

### SUMMARY OF THE INVENTION

The electrical storage apparatus according to one aspect of the invention has a first electrical storage module and a second electrical storage module that are arranged in a first direction. A passage for moving air in a second direction orthogonal to the first direction is formed between the first electrical storage module and the second electrical storage module, and the air is used for regulating temperature of the electrical storage modules.

Each of the electrical storage modules has a plurality of cylindrical electrical storage elements, a support plate and a casing. The support plate supports a portion of each of the electrical storage elements, and the plurality of electrical storage elements supported by the support plate are arranged such that an axis of each of the electrical storage elements is orthogonal to a plane formed along the first direction and the second direction. The casing surrounds the plurality of electrical storage elements and the support plate to form a space in which the air moves. The casing has an air intake opening for the air from the passage to move into the space, and an air discharge opening for the air in the space to move out of the casing.

According to the above aspect, air can be supplied to both of a first electrical storage module and a second electrical storage module only by flowing the air in a passage formed between the first electrical storage module and the second electrical storage module. That is, the passage for supplying air to the first electrical storage module and the second electrical storage module can be shared, without necessity of providing chambers for supplying air for the first electrical storage module and the second electrical storage module respectively. Additionally, if the passage for supplying air to the first electrical storage module and the second electrical storage module is shared, the electrical storage apparatus can be downsized.

If the air passes through an air intake opening, the air moves in a space surrounded by the casing and contacts a plurality of electrical storage elements, thereby it is possible to regulate temperature of the electrical storage elements. The air after contacting the electrical storage elements, i.e. the air after temperature regulation, may be discharged from an air discharge opening.

The casing may have a first side wall and a second side wall, the first side wall may be arranged and formed with a plurality of the air intake openings in the second direction, and the second side wall may be opposite to the first side wall in the first direction and formed with the air discharge opening. Herein, in the casing, the air can move from the air intake openings towards the air discharge opening, that is, from the first side wall towards the second side wall. Thus, in the casing, deflection of air flow is prevented, and it is easy to make the air contact all the electrical storage elements and to regulate the temperature of all the electrical storage elements.

Additionally, by forming the air intake opening and the air discharge opening respectively at the first side wall and the second side wall that are opposite in the first direction, the same structure may be used for the first electrical storage module and the second electrical storage module. That is, when the first electrical storage module and the second electrical storage module are arranged in the first direction, the second electrical storage module may be formed if the first electrical storage module is turned around in the plane formed along the first direction and the second direction.

A temperature sensor detecting temperature in the space may be disposed at each of the electrical storage modules. Herein, the temperature sensor may be disposed in a center of the space in the second direction and at a position adjacent to the second side wall. Additionally, an opening area of the air intake opening formed at two end sides of the first side wall in the second direction may be made greater than an opening area of the air intake opening formed at a central side of the first side wall in the second direction.

Thus, as described below, the highest temperature and the lowest temperature of each of the electrical storage modules (in the space) can be known by disposing only one temperature sensor at each of the electrical storage modules. Herein, it is preferable that the highest temperature and the lowest temperature of the electrical storage module are known when the temperature of the electrical storage module is regulated and when the electrical storage module is charged and discharged.

In the space of each of the electrical storage modules, the air moves from the first side wall towards the second side wall. By making the opening areas of the air intake openings different from each other as described above, the amount of air moving at the two end sides of the space in the second direction can be increased as compared to the amount of air moving at the central side of the space in the second direction. Herein, as the amount of air increases, it is easier to perform temperature regulation of the electrical storage elements by the air, and as the amount of air decreases, it is more difficult to perform temperature regulation of the electrical storage elements by the air. Additionally, in the moving path of the air from the first side wall towards the second side wall, as it is closer to the downstream side, or in other words closer to the second side wall, it is more difficult to perform temperature regulation of the electrical storage elements by the air.

Therefore, when the electrical storage module is cooled, temperature at the position where the temperature sensor is disposed tends to become the highest. Additionally, when the electrical storage module is heated, temperature at the position where the temperature sensor is disposed tends to become the lowest. Therefore, the temperature detected by the temperature sensor will indicate the highest temperature and the lowest temperature in the space, and the highest temperature and the lowest temperature in the space can be known using only one temperature sensor.

Additionally, as described above, when the first electrical storage module is turned around to form the second electrical storage module, in the second electrical storage module, an opening area of the air intake opening formed at two end sides of the first side wall in the second direction is also greater than an opening area of the air intake opening formed at a central side of the first side wall in the second direction. Thus, air can be supplied equally to the spaces in the electrical storage modules.

Additionally, by disposing the temperature sensor in a center of the space in the second direction, when the first electrical storage module is turned around to form the second electrical storage module, the temperature sensors can be disposed at the same position in the second direction in the first electrical storage module and the second electrical storage module. Thus, it is easy to make the wirings and the like of the temperature sensors of the same structure in the first electrical storage module and the second electrical storage module.

On the other hand, a gap between two air intake openings adjacent in the second direction and at the two end sides of the first side wall in the second direction may be smaller than a gap between two air intake openings adjacent in the second direction and at the central side of the first side wall in the second direction. In this case, the number of the air intake openings can be increased at the two end sides of the first side wall as compared to the central side. Thus, like the above case, the amount of air moving at the two end sides of the space in the second direction can be increased as compared to the amount of air moving at the central side of the space in the second direction. Therefore, the highest temperature and the lowest temperature in the space can be known by disposing only one temperature sensor at each of the electrical storage modules.

Not only may the gaps between two air intake openings adjacent in the second direction be made different, but also an opening area of the air intake opening formed at the two end sides of the first side wall in the second direction may be greater than an opening area of the air intake opening formed at the central side of the first side wall in the second direction.

### BRIEF DESCRIPTION OF THE DRAWINGS

Features, advantages, and technical and industrial significance of preferred embodiments of the invention will be described below with reference to the accompanying drawings, in which like numerals denote like elements, and wherein:

FIG. 1 is an exploded perspective view showing structure of a battery module;

FIG. 2 is a diagram showing circuit structure of the battery module;

FIG. 3 is a sectional view showing structure of a battery pack in a first embodiment;

FIG. 4 is a sectional view showing structure of a battery pack in a second embodiment;

FIG. 5 is a side view of the battery module in the second embodiment;

FIG. 6 is a diagram illustrating moving direction and amount of air in the battery module in the second embodiment;

FIG. 7 is a diagram showing temperature distribution in the battery module when air for cooling is supplied in the second embodiment;

FIG. 8 is a diagram showing temperature distribution in the battery module when air for heating is supplied in the second embodiment;

FIG. 9 is a side view of a battery module in a modified example of the second embodiment; and

FIG. 10 is a side view of a battery module in another modified example of the second embodiment.

### DETAILED DESCRIPTION OF EMBODIMENTS

Embodiments of the invention will be described below.

### First Embodiment

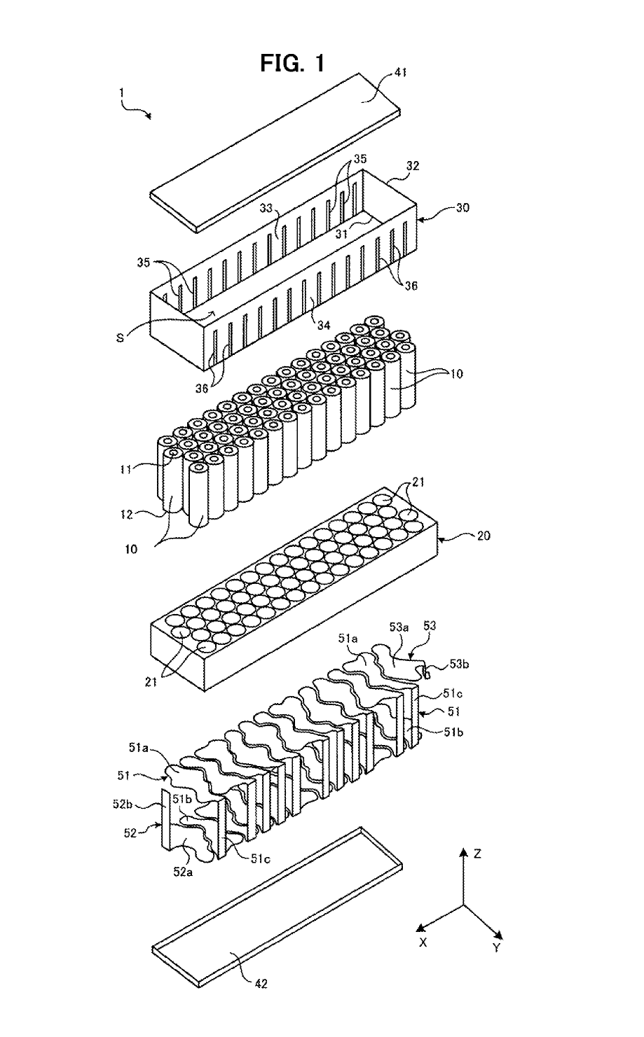

FIG. 1 is an exploded perspective view showing structure of a battery module (corresponding to an electrical storage module of the invention). In FIG. 1, X direction, Y direction and Z direction are directions orthogonal to one another. In this embodiment, Z direction corresponds to the vertical direction. Furthermore, in other accompanying drawings, the relationship among X direction, Y direction and Z direction is the same as that shown in FIG. 1.

The battery module 1 has a plurality of (any) single cells 10. The single cell 10 is a so-called cylindrical single cell 10. The cylindrical single cell 10 has an axis extending in a specified direction (Z direction), and a cross sectional shape of the single cell 10 in a plane (X-Y plane) orthogonal to a length direction of the single cell 10 is formed as circular. A positive terminal 11 and a negative terminal 12 are disposed at two ends of the single cell 10 in the length direction.

A secondary battery such as a nickel-metal hydride battery, a lithium ion battery may be used as the single cell 10. Also, an electrical double layer capacitor may be used instead of the secondary battery. Herein, the secondary battery and the electrical double layer capacitor correspond to an electrical storage element of the invention.

A support plate 20, disposed along the X-Y plane, has a plurality of through holes 21 arranged in the X-Y plane. The through hole 21 extends in Z direction through the support plate 20, and is formed in a shape following an outer peripheral face of the single cell 10. A portion of each of the single cells 10 is inserted in each of the through holes 21. By inserting the single cells 10 into the through holes 21, the support plate 20 can support the single cell 10 in a state where the length direction of the single cell 10 becomes Z direction, and the plurality of single cells 10 are arranged in the X-Y plane. Herein, the axis of the single cell 10 is orthogonal to the X-Y plane.

By arranging the plurality of single cells 10 in the X-Y plane, the positive terminals 11 of the plurality of single cells 10 are disposed in the same plane (in the X-Y plane). In other words, the negative terminals 12 of the plurality of single cells 10 are disposed in the same plane (in the X-Y plane). In this embodiment, the positive terminals 11 are located above the battery module 1, and the negative terminals 12 are located below the battery module 1, nevertheless these are not limitative. Specifically, the negative terminals 12 may be located above the battery module 1, and the positive terminals 11 may be located below the battery module 1.

Furthermore, in this embodiment, the total number of the through holes 21 is equal to that of the single cells 10, however the total number of the through holes 21 may also be less than that of the single cells 10. Herein, by appropriately setting the shape of the through hole 21 in the X-Y plane, multiple single cells 10 may be inserted into one through hole 21. Thus, the total number of the through holes 21 becomes less than that of the single cells 10.

Because the dimension of the support plate 20 in Z direction is smaller than that of the single cell 10 in Z direction, a portion of the single cell 10 (a portion at the positive terminal 11 side) protrudes above the support plate 20 from the through hole 21 when the single cell 10 is inserted into the through hole 21. Also, when the single cell 10 is inserted into the through hole 21, the negative terminal 12 protrudes below the support plate 20 from the through hole 21.

When the single cell 10 is inserted into the through hole 21, a spacer formed of elastic material such as resin or the like may be disposed between the outer peripheral face of the single cell 10 and an inner wall surface of the through hole 21. Thus, it is easy to fix the single cell 10 relative to the through hole 21.

The support plate 20 may be formed of material with excellent thermal conductivity, such as metal or the like. Thus, for example, it is easy to conduct heat generated in the single cells 10 to the support plate 20, so heat dissipation of the single cells 10 can be improved. Herein, if the spacer disposed between the outer peripheral face of the single cell 10 and the inner wall surface of the through hole 21 is formed of insulating material such as resin or the like, it is possible to achieve an insulation state between the single cells 10 and the support plate 20. Furthermore, if an insulating layer formed of resin or the like is formed on the outer peripheral face of the single cell 10, it is possible to achieve an insulation state between the single cells 10 and the support plate 20 even though a spacer is not formed of insulating material.

A side casing (corresponding to a casing of the invention) 30 is fixed to the support plate 20, and surrounds in the X-Y plane the plurality of single cells 10 protruding upwards from the support plate 20. A space S formed inside the side casing 30 is used as a flow passage for moving air, and the air is used to regulate temperature of the single cells 10. The flow passage (space S) is formed by the side casing 30, the support plate 20 and an upper cover 41. Herein, an opening portion 31 formed at a lower end of the side casing 30 is fixed to the support plate 20, and an opening portion 32 formed at an upper end of the side casing 30 is covered by the upper cover 41.

The side casing 30 has a first side wall 33 and a second side wall 34 that are opposite in Y direction. A plurality of air intake openings 35 arranged in X direction are formed at the first side wall 33. Each of the air intake openings 35 is formed in rectangular shape, and extends in Z direction. The air intake openings 35 through the first side wall 33 are used to draw air for regulating temperature of the single cells 10 into the space S.

The opening area, number, position, and shape of the air intake openings 35 may be set appropriately by taking account of regulation of temperature of all the single cells 10 included in the battery module 1.

A plurality of air discharge openings 36 arranged in X direction are formed at the second side wall 34. Each of the air discharge openings 36 is formed in rectangular shape, and extends in Z direction. The air discharge openings 36 through the second side wall 34 are used to discharge the air in the space S out of the side casing 30.

In the space S, the air moves from the air intake openings 35 towards the air discharge openings 36. That is, the air in the space S moves in Y direction. In this embodiment, the number of the air discharge openings 36 is equal to that of the air intake openings 35, and each of the air discharge openings 36 is disposed at a position opposite to each of the air intake openings 35 in Y direction. Furthermore, the opening area, number, position, and shape of the air discharge openings 36 may be set appropriately by taking account of movement in Y direction of the air drawn from the air intake openings 35.

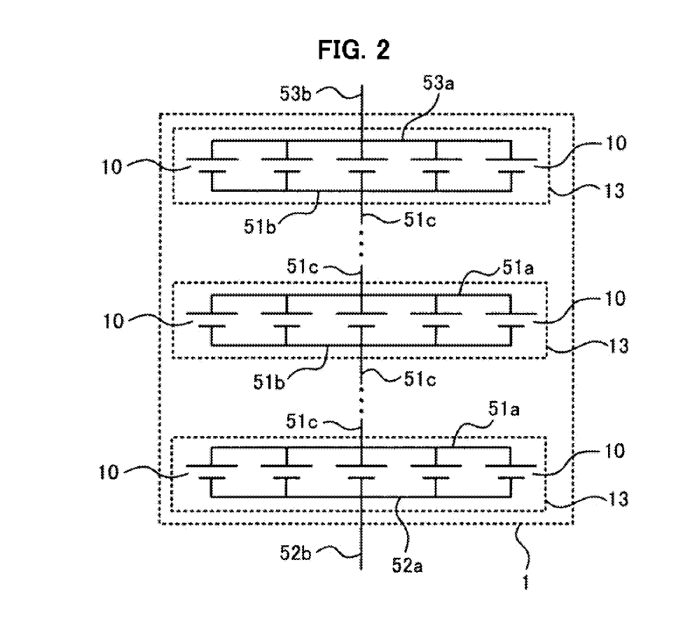

As shown in FIG. 2, the plurality of single cells 10 are divided into a plurality of battery blocks 13. Each of the battery blocks 13 consists of a plurality of single cells 10 connected in parallel. Additionally, the plurality of battery blocks 13 are connected in series. A plurality of bus bars 51 shown in FIG. 1 are used to connect a plurality of the single cells 10 constituting the battery block 13 in parallel and connect two battery blocks 13 in series.

As shown in FIG. 1, the bus bar 51 has a positive plate 51a, a negative plate 51b and a leading wire 51c, and the leading wire 51c extends in Z direction and is connected with the positive plate 51a and the negative plate 51b. In the circuit structure shown in FIG. 2, positions of the positive plate 51a, the negative plate 51b and the leading wire 51c are also shown. As shown in FIG. 1, the plurality of bus bars 51 have different shapes from one another, but have the same function as will be described below.

The positive plate 51a is disposed between the positive terminals 11 of the single cells 10 and the upper cover 41, and is connected with positive terminals 11 of a plurality of the single cells 10 constituting a battery block 13. The negative plate 51b is disposed between the negative terminals 12 of the single cells 10 and lower cover 42, and is connected with negative terminals 12 of a plurality of the single cells 10 constituting a battery block 13. Herein, the lower cover 42 is fixed to the support plate 20.

The battery block 13 connected with the positive plate 51a and the battery block 13 connected with the negative plate 51b are different from each other. Thus, two battery blocks 13 can be connected in series via the bus bar 51.

As shown in FIG. 1, a bus bar 52 has a negative plate 52a and a leading wire 52b extending upwards (in Z direction) from the negative plate 52a. In the circuit structure shown in FIG. 2, positions of the negative plate 52a and the leading wire 52b are also shown. The negative plate 52a is disposed between the negative terminals 12 of the single cells 10 and the lower cover 42, and is connected with the negative terminals 12 of a plurality of single cells 10 constituting a battery block 13. Herein, as shown in FIG.2, the battery block 13 connected with the negative plate 52a is a battery block 13 located at one end of a plurality of battery blocks 13 connected in series. The leading wire 52b is used as the negative terminal of the battery module 1.

As shown in FIG. 1, a bus bar 53 has a positive plate 53a and a leading wire 53b extending downwards (in Z direction) from the positive plate 53a. In the circuit structure shown in FIG. 2, positions of the positive plate 53a and the leading wire 53b are also shown. The positive plate 53a is disposed between the positive terminals 11 of the single cells 10 and the upper cover 41, and is connected with positive terminals of a plurality of single cells 10 constituting a battery block 13. Herein, as shown in FIG. 2, the battery block 13 connected with the positive plate 53a is a battery block 13 located at the other end of the plurality of battery blocks 13 connected in series. The leading wire 53b is used as the positive terminal of the battery module 1.

The leading wires 51c are disposed outside of the side casing 30 and the support plate 20. Therefore, a connection portion of the leading wire 51c with the positive plate 51a is located between the upper end (the opening portion 32) of the side casing 30 and the upper cover 41. Additionally, a connection portion of the leading wire 51c with the negative plate 51b is located between the support plate 20 and the lower cover 42.

The leading wires 51c are disposed along the second side wall 34 of the side casing 30. Herein, the leading wire 51c is disposed between two air discharge openings 36 adjacent in X direction, without blocking the air discharge openings 36. Furthermore, the leading wires 51c may also be disposed along the first side wall 33 of the side casing 30. In this case, the leading wire 51c may be disposed between two air intake openings 35 adjacent in X direction, such that the air intake openings 35 are not blocked by the leading wires 51c.

The leading wire 52b is disposed outside of the side casing 30 and the support plate 20. Therefore, a connection portion of the leading wire 52b with the negative plate 52a is located between the support plate 20 and the lower cover 42. The leading wire 53b is disposed outside of the side casing 30. Therefore, a connection portion of the leading wire 53b with the positive plate 53a is located between the upper end (the opening portion 32) of the side casing 30 and the upper cover 41.

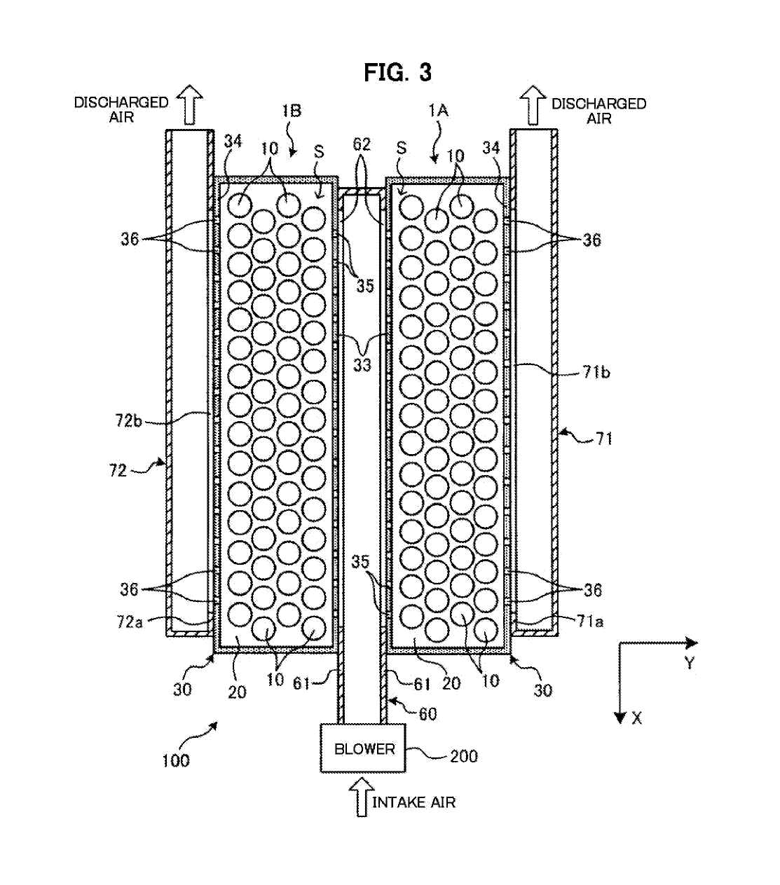

Next, structure of a battery pack will be described using FIG. 3. FIG. 3 is a sectional view when the battery pack is cut in the X-Y plane.

The battery pack 100 has two battery modules 1A, 1B, one air intake duct 60 and a pair of air discharge ducts 71, 72. The battery modules 1A, 1B has the same structure, i.e. the structure of the battery module 1 shown in FIG. 1. The X direction and Y direction shown in FIG. 3 denote directions when the battery module 1A becomes the battery module 1 shown in FIG. 1. The battery module 1B is formed by turning the battery module 1A by 180 degrees in the X-Y plane shown in FIG. 3.

The battery modules 1A, 1B may be connected in series or in parallel. When the battery modules 1A, 1B are connected in series, the leading wire 53b of bus bar 53 in the battery module 1A and the leading wire 52b of bus bar 52 in the battery module 1B are connected via a cable or the like. When the battery modules 1A, 1B are connected in parallel, the leading wires 53b of bus bars 53 in the battery modules 1A, 1B are connected to each other and the leading wires 52b of bus bars 52 in the battery modules 1A, 1B are connected to each other.

The battery modules 1A, 1B are arranged in Y direction (corresponding to the first direction of the invention). The air intake duct 60 extends in X direction (corresponding to the second direction of the invention) and is disposed between the two battery modules 1A, 1B in Y direction. The air intake duct 60 has a pair of side walls 61 opposite in Y direction, and one side wall 61 is in contact with a first side wall 33 of the side casing 30 in the battery module 1A, while the other side wall 61 is in contact with a first side wall 33 of the side casing 30 in the battery module 1B. Opening portions 62 are respectively formed on the pair of side walls 61.

The opening portion 62 is formed at such a position that air intake openings 35 are not blocked. In this embodiment, one opening portion 62 is formed on each of the side walls 61, nevertheless this is not limitative. That is, it will suffice as long as the opening portion 62 does not block the air intake openings 35, and the shape and position of the opening portion 62 may be appropriately set by taking account of this point.

A blower 200 is connected to the air intake duct 60, and air for regulating temperature of single cells 10 is drawn into the air intake duct 60 by driving the blower 200. Herein, in order to suppress temperature increase of the single cells 10, air for cooling the single cells 10, i.e. air with a temperature lower than that of the single cells 10 is drawn into the air intake duct 60. Additionally, in order to suppress temperature decrease of the single cells 10, air for heating the single cells 10, i.e. air with a temperature higher than that of the single cells 10, is drawn into the air intake duct 60.

When the battery pack 100 is mounted in a vehicle, air in the cabin may be drawn into the air intake duct 60. The cabin refers to a space in which passengers ride. The air temperature in the cabin is usually regulated by an air conditioner mounted in the vehicle, and the air in the cabin is suitable for temperature regulation of the single cells 10.

The air discharge duct 71 extends along X direction, and is disposed at an opposite side to the air intake duct 60 side with respect to the battery module 1A. That is, the battery module 1A is disposed between the air intake duct 60 and the air discharge duct 71 in Y direction. A side wall 71a of the air discharge duct 71 is in contact with a second side wall 34 of side casing 30 in the battery module 1A, and an opening portion 71b is formed at the side wall 71a.

The opening portion 71b is formed at such a position that the air discharge openings 36 are not blocked. In this embodiment, one opening portion 71b is formed at the air discharge duct 71, nevertheless this is not limitative. That is, it will suffice as long as the opening portion 71b does not block the air discharge openings 36, and the shape and position of the opening portion 71b may be appropriately set by taking account of this point.

The air discharge duct 72 extends along X direction, and is disposed at an opposite side to the air intake duct 60 side with respect to the battery module 1B. That is, the battery module 1B is disposed between the air intake duct 60 and the air discharge duct 72 in Y direction. A side wall 72a of the air discharge duct 72 is in contact with a second side wall 34 of side casing 30 in the battery module 1B, and an opening portion 72b is formed at the side wall 72a.

The opening portion 72b is formed at such a position that the air discharge openings 36 are not blocked. In this embodiment, one opening portion 72b is formed at the air discharge duct 72, nevertheless this is not limitative. That is, it will suffice as long as the opening portion 72b does not block the air discharge openings 36, and the shape and position of the opening portion 72b may be appropriately set by taking account of this point.

Next, air flow while temperature of the single cells 10 is regulated, in the battery pack 100 shown in FIG. 3, will be described.

Air drawn by the air intake duct 60 by driving the blower 200, after moving along the air intake duct 60, passes through the opening portion 62 and the air intake openings 35, and then enters the space S of each of the battery modules 1A, 1B. The air entering the space S exchanges heat with the single cells 10 by contacting the single cells 10 during movement from the air intake openings 35 to the air discharge openings 36.

For example, when the temperature of the single cells 10 increases, the temperature increase of the single cells 10 can be suppressed by contacting the air for cooling with the single cells 10. Additionally, when the temperature of the single cells 10 decreases, the temperature decrease of the single cells 10 can be suppressed by contacting the air for heating with the single cells 10.

By moving air from the air intake openings 35 to the air discharge openings 36, the air can be made to flow along Y direction in the whole space S of each of the battery modules 1A, 1B. Thus, it is possible to prevent deflection of air flow in the space S, and the air contacts all the single cells 10 constituting the battery modules 1A, 1B.

The air after contacting the single cells 10 of the battery module 1A (i.e. the air after heat exchange) passes through the air discharge openings 36 and the opening portion 71b into the inside of the air discharge duct 71. Additionally, the air after contacting the single cells 10 of the battery module 1B (i.e. the air after heat exchange) passes through the air discharge openings 36 and the opening portion 72b into the inside of the air discharge duct 72. The air after heat exchange moves along the air discharge ducts 71, 72, and then is discharged out of the battery pack 100.

According to this embodiment, it is possible to use one air intake duct 60 to supply air to two battery modules 1A, 1B, respectively. Thus, the number of air intake ducts 60 can be reduced as compared to the case where air intake ducts 60 are respectively disposed at the two battery modules 1A, 1B. Additionally, because air can be directly supplied to each of the battery modules 1A, 1B from the air intake duct 60, temperatures of the air supplied to the battery modules 1A, 1B can be made equal. Thus, it is possible to suppress uneven temperature regulation of the single cells 10 in the battery modules 1A, 1B.

If an air intake duct 60 is disposed at each of the battery modules 1A, 1B, two air intake ducts 60 will be disposed between the two battery modules 1A, 1B, thereby upsizing the battery pack 100 in Y direction. According to this embodiment, only one air intake duct 60 is used, and therefore it is possible to suppress upsizing of the battery pack 100 in Y direction.

In FIG. 3, the air discharge ducts 71, 72 are separated, but they may also be connected at a downstream side of the air flow passage. Additionally, the blower 200 is connected with the air intake duct 60, but it may also be connected with the air discharge ducts 71, 72. Even though in this case, air for regulating temperature of the single cells 10 can be drawn into the air intake duct 60 by driving the blower 200. Additionally, as described above, if the air discharge ducts 71, 72 are connected and the blower 200 is disposed closer to the downstream side of the air flow passage than the connection portion, it will suffice to provide only one blower 200, without necessity of providing a blower 200 for each of the air discharge ducts 71, 72.

In this embodiment, the air discharge ducts 71, 72 are provided, but the air discharge ducts 71, 72 may also be omitted. That is, the air after heat exchange with the single cells 10 may be discharged out of the battery modules 1A, 1B only from the air discharge openings 36.

Additionally, in this embodiment, the battery modules 1A, 1B, the air intake duct 60 and the air discharge ducts 71, 72 are arranged in the X-Y plane (in the plane orthogonal to the vertical direction), nevertheless this is not limitative. For example, in FIG. 3, Y direction may be made as Z direction. That is, the battery modules 1A, 1B, the air intake duct 60, and the air discharge ducts 71, 72 may be arranged in Z direction.

In this embodiment, the positive plates 51a are disposed above the single cells 10 and the negative plates 51b are disposed below the single cells 10, but the positive plates 51a and the negative plates 51b may be disposed above or below the single cells 10. Specifically, if, in two battery blocks 13 connected in series, the positive terminals 11 of single cells 10 included in one battery block 13 and the negative terminals 12 of single cells 10 included in the other battery block 13 are disposed in the same plane (in the X-Y plane), the positive plates 51a and the negative plates 51b may be disposed in the same plane (in the X-Y plane). In this case, the leading wires 51c may also not extend in Z direction as shown in FIG. 1.

### Second Embodiment

A second embodiment of the invention will be described. Herein, like numerals are used for components with same functions as those described in the first embodiment, and detailed descriptions thereof will be omitted. This embodiment provides a structure capable of reducing the number of temperature sensor detecting temperature of the battery modules 1A, 1B.

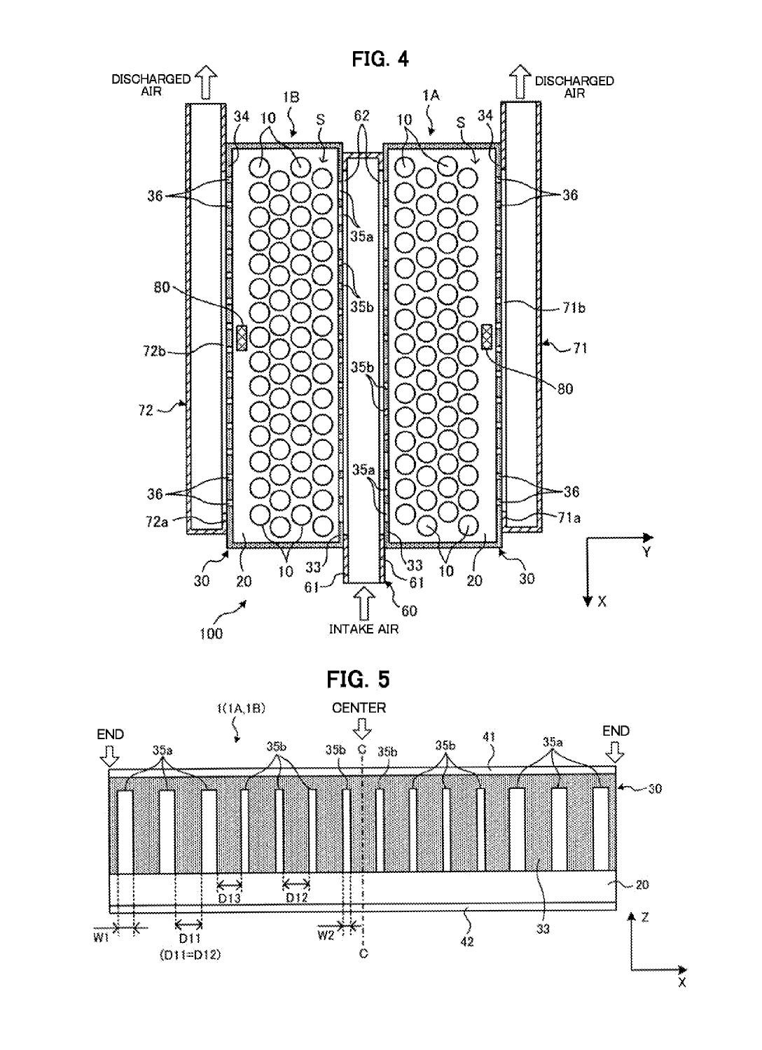

FIG. 4 is a diagram corresponding to FIG. 3. Herein, a temperature sensor 80 is fixed to the support plate 20 of each of the battery modules 1A, 1B. The temperature sensor 80 is disposed in the space S of each of the battery modules 1A, 1B and detects the temperature within the space S. The temperature sensor 80 is disposed at a central portion of each of the battery modules 1A, 1B in X direction and at a position adjacent to the second side wall 34. The temperature detected by the temperature sensor 80 is considered as the temperature when driving of the blower 200 is controlled and charging and discharging of the battery pack 100 is controlled.

Two types of air intake openings 35a, 35b are formed at the first side wall 33 of the side casing 30 of each of the battery modules 1A, 1B. As shown in FIG. 5, a width (size in X direction) W1 of the air intake opening 35a is greater than a width (size in X direction) W2 of the air intake opening 35b. FIG. 5 is a side view of the battery module 1A, in which the bus bars 51-53 are omitted. Because sizes of the air intake openings 35a, 35b in Z direction are equal to each other, an opening area of the air intake opening 35a is greater than an opening area of the air intake opening 35b.

In this embodiment, the opening area of the air intake opening 35a is made greater than that of the air intake opening 35b by making the widths W1, W2 different from each other, nevertheless this is not limitative. The opening area of the air intake opening 35a may also be made greater than that of the air intake opening 35b by appropriately setting shapes of the air intake openings 35a, 35b in the X-Z plane.

Herein, the opening area of the air intake opening 35b may be set by taking account of the minimum amount of air for regulating the temperature of the single cells 10. On the other hand, the opening area of the air intake opening 35a is greater than the opening area of the air intake opening 35b as set above.

The air intake openings 35a are disposed at two end sides of the first side wall 33 in X direction. Additionally, the air intake openings 35b are disposed at a central side of the first side wall 33 in X direction. That is, the air intake openings 35a are located at the two end sides of the first side wall 33 in X direction as compared to the air intake openings 35b, and the air intake openings 35b are located at the central side of the first side wall 33 in X direction as compared to the air intake openings 35a.

A gap D11 between two air intake openings 35a adjacent in X direction is equal to a gap D12 between two air intake openings 35b adjacent in X direction. Herein, a gap D13 between the air intake openings 35a and 35b adjacent in X direction may either be equal to or be different from the gaps D11, D12.

A plurality of air intake openings 35a disposed at the two end sides of the first side wall 33 in X direction are disposed symmetrically relative to a reference line C (with reference to FIG. 5) passing through the center of the first side wall 33 in X direction. Additionally, a plurality of air intake openings 35b disposed at the central side of the first side wall 33 in X direction are disposed symmetrically relative to the reference line C.

If the opening areas of the air intake openings 35a, 35b are different from each other, the amounts of air entering the space S from the air intake openings 35a, 35b are different from each other. Because the opening area of the air intake opening 35a is greater than that of the air intake opening 35b, the amount of air entering the space S from the air intake openings 35a is larger than that entering the space S from the air intake openings 35b. Thus, the air tends to flow at the two end sides of each of the battery modules 1A, 1B in X direction, as compared to the central side of each of the battery modules 1A, 1B in X direction.

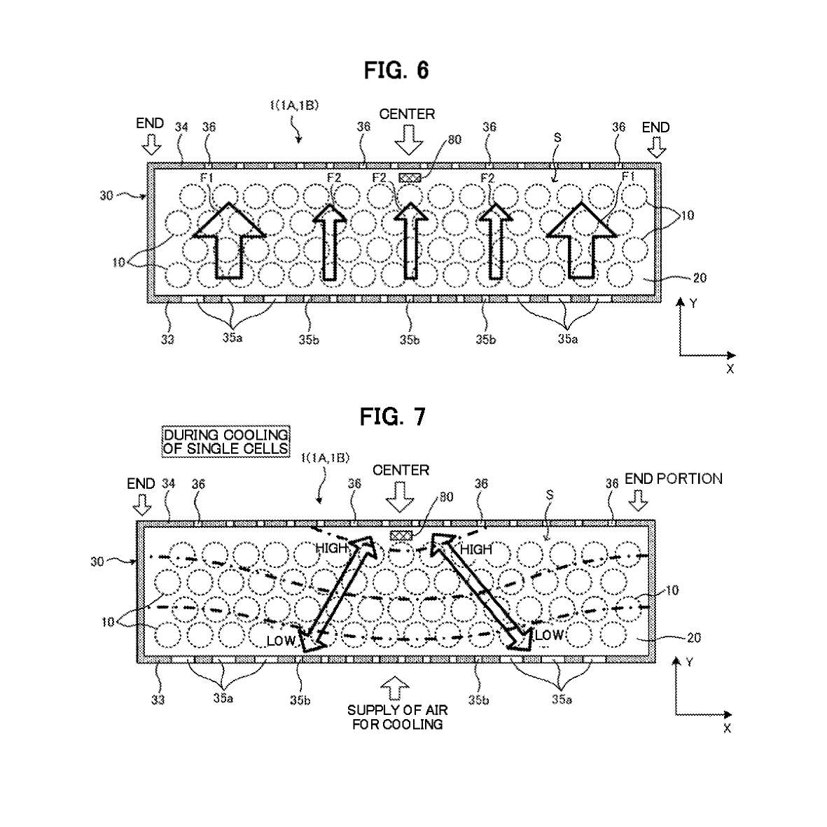

The air entering the space S from the air intake openings 35a moves along a direction (Y direction) as indicated by an arrow F1 in FIG. 6, and the air entering the space S from the air intake openings 35b moves along a direction (Y direction) as indicated by an arrow F2 in FIG. 6. Herein, widths of the arrows F1, F2 denote the amount of air. That is, because the width of the arrow F1 is greater than that of the arrow F2, the amount of air moving along the direction of the arrow F1 is larger than that moving along the direction of the arrow F2.

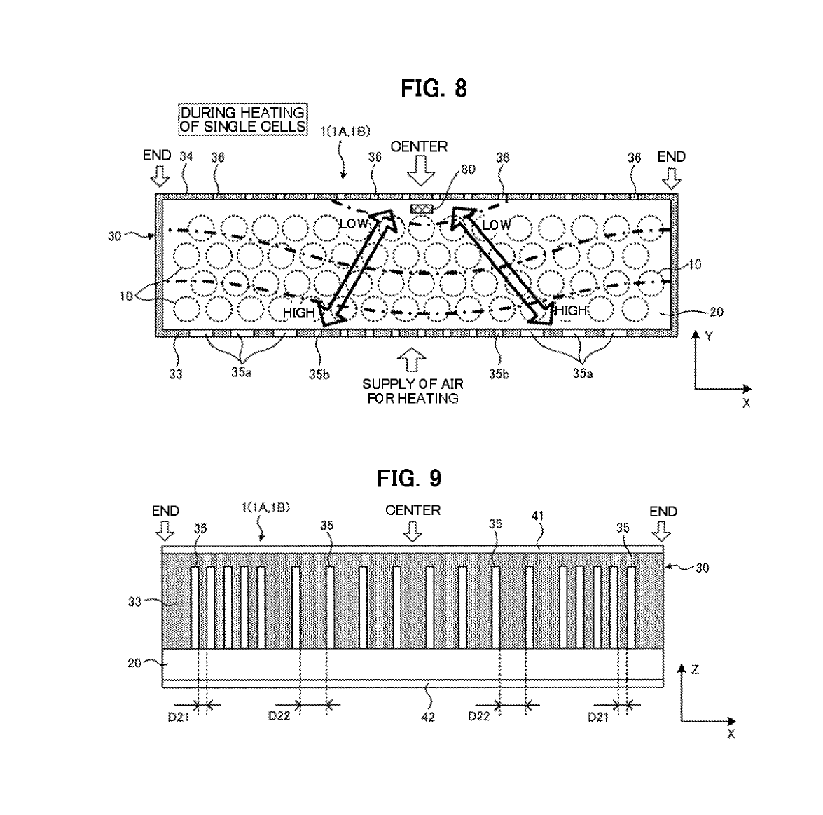

By making the amounts of air different in accordance with positions in X direction in the space S of each of the battery modules 1A, 1B, temperature distributions shown in FIG. 7 and FIG. 8 can be generated in the space S. FIG. 7 indicates a temperature distribution in the space S when air for cooling is supplied to the battery modules 1 (1A, 1B), and FIG. 8 indicates a temperature distribution in the space S when air for heating is supplied to the battery modules 1 (1A, 1B).

The dot dash lines shown in FIG. 7 and FIG. 8 are lines that connect parts having the same temperature (isotherms). In the temperature distribution shown in FIG. 7, the temperature increases from the air intake openings 35a, 35b towards the position where the temperature sensor 80 is disposed.

Because the amount of air entering the space S from the air intake opening 35a is larger than that entering the space S from the air intake opening 35b, it can be known from the isotherms shown in FIG. 7 that the temperature tends to decrease at the two end sides of the space S in X direction, as compared to the central side of the space S in X direction.

On the other hand, when the air moves from the air intake openings 35a towards the air discharge openings 36, the air after heat exchange with single cells 10 located at an upstream side of the moving path of the air contacts the single cells 10 located at a downstream side of the moving path of the air. Therefore, heat exchange of the single cells 10 at the downstream side with the air is suppressed, as compared to the single cells 10 at the upstream side. Therefore, the temperature tends to increase from the air intake openings 35a, 35b towards the air discharge openings 36.

According to the above reasons, the temperature distribution shown in FIG. 7 is generated. As shown in FIG. 7, during cooling of the single cells 10, temperature at the position where the temperature sensor 80 is disposed becomes the highest. Therefore, when air for cooling is supplied to the battery modules 1 (1A, 1B), the temperature detected by the temperature sensor 80 represents the highest temperature within the space S.

In the temperature distribution shown in FIG. 8, the temperature decreases from the air intake openings 35a, 35b towards the position where the temperature sensor 80 is disposed.

Because the amount of air entering the space S from the air intake opening 35a is larger than that entering the space S from the air intake opening 35b, it can be known from the isotherms shown in FIG. 8 that the temperature tends to increase at the two end sides of the space S in X direction, as compared to the central side of the space S in X direction.

On the other hand, when the air moves from the air intake openings 35a towards the air discharge openings 36, the air after heat exchange with single cells 10 located at an upstream side of the moving path of the air contacts the single cells 10 located at a downstream side of the moving path of the air. Therefore, heat exchange of the single cells 10 at the downstream side with the air is suppressed, as compared to the single cells 10 at the upstream side. Therefore, the temperature tends to decrease from the air intake openings 35a, 35b towards the air discharge openings 36.

According to the above reasons, the temperature distribution shown in FIG. 8 is generated. As shown in FIG. 8, during heating of the single cells 10, temperature at the position where the temperature sensor 80 is disposed becomes the lowest. Therefore, when air for heating is supplied to the battery modules 1 (1A, 1B), the temperature detected by the temperature sensor 80 represents the lowest temperature within the space S.

The opening area and the number of the air intake openings 35a, 35b may be appropriately set so as to generate the temperature distributions shown in FIG. 7 and FIG. 8, that is, the highest temperature or the lowest temperature is shown at the position where the temperature sensor 80 is disposed.

When driving of the blower 200 and charging and discharging of the battery pack 100 are controlled, it is required to know the highest and lowest temperatures in the battery modules 1A, 1B.

For example, when air for cooling is supplied to the battery modules 1A, 1B, temperature increase of the battery modules 1A, 1B as a whole is preferably to be suppressed. Therefore, it is required to know the highest temperature in the battery modules 1A, 1B. As described using FIG. 7, as long as the temperature detected by the temperature sensor 80 is monitored, the highest temperature in the battery modules 1A, 1B can be known.

Additionally, when air for heating is supplied to the battery modules 1A, 1B, temperature decrease of the battery modules 1A, 1B as a whole is preferably to be suppressed. Therefore, it is required to know the lowest temperature in the battery modules 1A, 1B. As described using FIG. 8, as long as the temperature detected by the temperature sensor 80 is monitored, the lowest temperature in the battery modules 1A, 1B can be known.

On the other hand, when the battery modules 1A, 1B are charged and discharged, an upper limit electric power value of allowing charging and an upper limit electric power value of allowing discharging are set, and the charging and discharging are controlled so as not to exceed these upper limit electric power values. The upper limit electric power values are set according to temperature of the battery modules 1A, 1B. Specifically, correspondence relationship (a map or calculation expression) between the upper limit electric power values and temperature of the battery modules 1A, 1B is obtained in advance, and upper limit electric power values corresponding to the temperature of the battery modules 1A, 1B are set.

Herein, in order to suppress excessive heat generation of the single cells 10, the higher the temperature of the battery modules 1A, 1B is, the lower the upper limit electric power values need to be. Additionally, to ensure input and output performance of the single cells 10, the lower the temperature of the battery modules 1A, 1B is, the lower the upper limit electric power values need to be.

When uneven temperatures are generated in the battery modules 1A, 1B, it is preferable to know the highest temperature and the lowest temperature in setting the upper limit electric power values. That is, it is preferable to set upper limit electric power values corresponding to the highest temperature and the lowest temperature. As described using FIG. 7, during cooling of the single cells 10, the highest temperature in the battery modules 1A, 1B can be known by monitoring the temperature detected by the temperature sensor 80. Additionally, as described using FIG. 8, during heating of the single cells 10, the lowest temperature in the battery modules 1A, 1B can be known by monitoring the temperature detected by the temperature sensor 80.

In this embodiment, as shown in FIG. 7 and FIG. 8, in the space S of the battery modules 1 (1A, 1B), the position indicating the highest temperature is made coincident with the position indicating the lowest temperature. As long as the temperature sensor 80 is disposed only at this position, the highest temperature and the lowest temperature in each of the battery modules 1A, 1B can be detected.

Additionally, because the temperature sensor 80 is disposed only at one position, an increase in the number of the temperature sensors 80 can be suppressed. If the temperature sensors 80 are disposed at multiple positions in the space S, although the highest temperature and the lowest temperature can be known, the number of the temperature sensors 80 tends to increase. In this embodiment, as described above, the amounts of air moving in the space S are made different to intentionally make a position (the same position) indicating the highest temperature and the lowest temperature, and the highest temperature and the lowest temperature within the space S can be known by disposing a temperature sensor 80 only at this position.

Also, as shown in FIG. 4, the battery modules 1A, 1B with the same structure may be used when two battery modules 1A, 1B are disposed. That is, as long as the direction of the battery module 1A shown in FIG. 4 is turned by 180 degrees in the X-Y plane, it becomes the battery module 1B shown in FIG. 4.

Herein, the air intake openings 35a of the battery module 1A may be made opposite to the air intake openings 35a of the battery module 1B in Y direction, and the air intake openings 35b of the battery module 1A may be made opposite to the air intake openings 35b of the battery module 1B in Y direction. Thus, air can be supplied equally to the battery modules 1A, 1B from the air intake duct 60.

Additionally, the temperature sensor 80 is disposed in the center of the space S in X direction, and therefore, the temperature sensors 80 of the battery modules 1A, 1B can be disposed at the same position in X direction when the battery modules 1A, 1B are arranged as shown in FIG. 4. That is, the temperature sensors 80 of the battery modules 1A, 1B are disposed in the center of the battery pack 100 in X direction. Thus, in the battery modules 1A, 1B, it is easy to make the wirings and the like of the temperature sensors 80 of the same structure.

In this embodiment, the opening areas of the air intake openings 35a, 35b are made different so as to indicate the highest temperature and the lowest temperature at the position where the temperature sensor 80 is disposed, nevertheless this is not limitative. That is, as described using FIG. 6, the amount of air moving at the two end sides of the space S in X direction may be made larger than that moving at the central side of the space S in X direction.

For example, as shown in FIG. 9, a plurality of air intake openings 35 having the same opening area may be formed at the first side wall 33 of the side casing 30, and gaps between two air intake openings 35 adjacent in X direction may be made to vary. The narrower the gap between two air intake openings 35 adjacent in X direction is made, the more the amount of air entering the space S can be increased.

Therefore, as shown in FIG. 9, a gap D21 between two air intake openings 35 disposed at the two end sides of the first side wall 33 in X direction is made smaller than a gap D22 between two air intake openings 35 disposed at the central side of the first side wall 33 in X direction. In FIG. 9, air intake openings 35 disposed with the gap D21 and air intake openings 35 disposed with the gap D22 are formed at the first side wall 33.

The number of the air intake openings 35 disposed with the gap D21 and the number of the air intake openings 35 disposed with the gap D22 are appropriately set so as to generate the temperature distributions shown in FIG. 7 and FIG. 8.

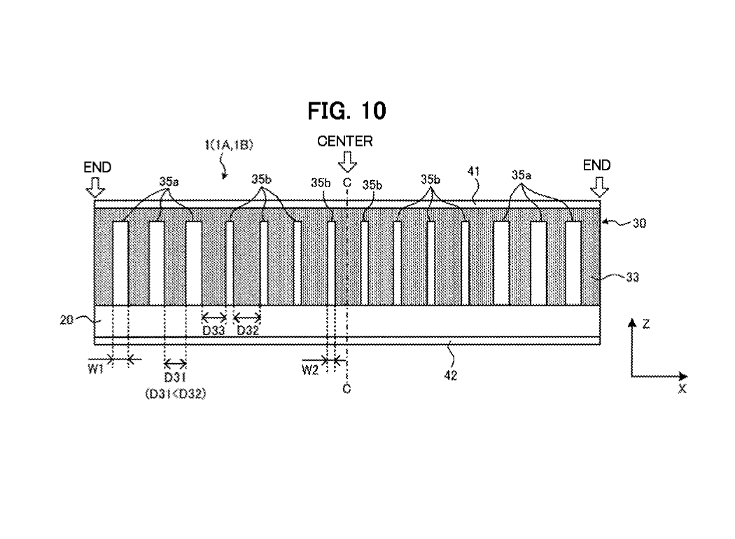

On the other hand, as shown in FIG. 10, two types of air intake openings 35a, 35b having different opening areas may be provided, and a gap D31 between two air intake openings 35a adjacent in X direction is made smaller than a gap D32 between two air intake openings 35b adjacent in X direction. In the structure shown in FIG. 10, like that shown in FIG. 5, the air intake openings 35a are disposed at the two end sides of the first side wall 33 in X direction, and the air intake openings 35b are disposed at the central side of the first side wall 33 in X direction.

Additionally, a width W1 of the air intake opening 35a is greater than a width W2 of the air intake opening 35b, and an opening area of the air intake opening 35a is greater than an opening area of the air intake opening 35b. The number of the air intake openings 35a, 35b is set appropriately, that is, the gaps D31, D32 are set appropriately, so as to generate the temperature distributions shown in FIG. 7 and FIG. 8.

In FIG. 10, a gap D33 between two air intake openings 35a, 35b adjacent in X direction may be set appropriately. For example, the gap D33 may be made equal to the gap D31 or the gap D32, or different from the gaps D31, D32. Even with the structure shown in FIG. 10, it is possible to make the amount of air moving at the two end sides of the space S in X direction larger than that moving at the central side of the space S in X direction.

In this embodiment, two types of air intake openings 35a, 35b are disposed, but three or more types of air intake openings 35 having different opening areas may also be disposed. That is, as described above, it will suffice to make the amount of air moving at the two end sides of the space S in X direction larger than that moving at the central side of the space S in X direction.

Specifically, air intake openings 35 with the largest opening area may be disposed at the two ends of the first side wall 33 in X direction. And a plurality of air intake openings 35 may be arranged in such a manner that the opening area of the air intake openings 35 decreases towards the center of the first side wall 33 in X direction. Herein, gaps between two air intake openings 35 adjacent in X direction may be equal, and may also be different. If gaps between two air intake openings 35 adjacent in X direction are made different, the gap may be enlarged from the two ends of the first side wall 33 in X direction towards the center of the first side wall 33 in X direction.

What is claimed is:

1. An electrical storage apparatus, comprising:
a first electrical storage module and a second electrical storage module that are arranged in a first direction; and
a passage for moving air in a second direction orthogonal to the first direction, formed between the first electrical storage module and the second electrical storage module, the air being used for regulating temperature of each of the electrical storage modules,
wherein each of the electrical storage modules has a plurality of cylindrical electrical storage elements, a support plate and a casing, the support plate supporting a portion of each of the electrical storage elements in a state where the plurality of electrical storage elements are arranged such that an axis of each of the electrical storage elements is orthogonal to a plane formed along the first direction and the second direction, and the casing surrounding the plurality of electrical storage elements and the support plate to form a space in which the air moves, and
wherein the casing has an air intake opening for moving the air from the passage into the space and an air discharge opening for moving the air in the space out of the casing.

2. The electrical storage apparatus according to claim 1, wherein:
the casing has a first side wall and a second side wall, the first side wall being arranged and formed with a plurality of the air intake openings in the second direction, and the second side wall being opposite to the first side wall in the first direction and formed with the air discharge opening;
each of the electrical storage modules has a temperature sensor detecting temperature in the space, the temperature sensor being disposed in a center of the space in the second direction and at a position adjacent to the second side wall; and
an opening area of the air intake opening formed at two end sides of the first side wall in the second direction is greater than an opening area of the air intake opening formed at a central side of the first side wall in the second direction.

3. The electrical storage apparatus according to claim 1, wherein:
the casing has a first side wall and a second side wall, the first side wall being arranged and formed with a plurality of the air intake openings in the second direction, and the second side wall being opposite to the first side wall in the first direction and formed with the air discharge opening;
each of the electrical storage modules has a temperature sensor detecting temperature in the space, the temperature sensor being disposed in a center of the space in the second direction and at a position adjacent to the second side wall; and
a gap between two air intake openings adjacent in the second direction and at two end sides of the first side wall in the second direction is smaller than a gap between two air intake openings adjacent in the second direction and at a central side of the first side wall in the second direction.

4. The electrical storage apparatus according to claim 3, wherein an opening area of the air intake opening formed at the two end sides of the first side wall in the second direction is greater than an opening area of the air intake opening formed at the central side of the first side wall in the second direction.
